(19) United States
(12) Patent Application Publication
(10) Pub. No.: US 2005/0039977 A1
(43) Pub. Date: Feb. 24, 2005

(54) Vibration-control platform

(76) Inventor: Vinh Thanh Vu, Colts Neck, NJ (US)

Correspondence Address: DEMONT & BREYER, LLC, SUITE 250, 100 COMMONS WAY, HOLMDEL, NJ, 07733, US

(21) Appl. No.: 10/945,283

(22) Filed: Sep. 20, 2004

Related U.S. Application Data
(63) Continuation-in-part of application No. 10/642,868, filed on Aug. 18, 2003.

(51) Int. Cl. F16F 15/00

(52) U.S. Cl. 181/209

(57) ABSTRACT

A vibration-control platform that includes a bottom plate having at least one well. The well receives a spherical vibration-control element, which is used to isolate an object from vibrations. The well has a rim and a dimple. In the illustrative embodiment, the rim is a planar region that is disposed beneath the surface of the bottom plate and surrounds the dimple. In use, the vibration-control element is seated in the dimple.

### STATEMENT OF RELATED CASES

This case is a continuation-in-part of co-pending U.S. patent application Ser. No. 10/642,868, which was filed on Aug. 18, 2003 and is incorporated by reference herein.

### FIELD OF THE INVENTION

The present invention relates generally to an article and method for reducing resonances and vibrations that are transmitted to a supported object.

### BACKGROUND OF THE INVENTION

Each musical instrument has its own unique resonance signature. This signature is what makes one type of instrument sound different from another and why two specimens of the same type of instrument do not sound the same. In a piece of music, it is the interplay of these unique resonance signatures that is crucial to conveying the musical idea of a composer, arranger, or performer.

It is a goal of an audio playback system, in particular a “high-end” audio system, to faithfully reproduce this interplay, as recorded on a recording medium (e.g., lp, cd, tape, etc.). To do so, the audio system must extract the recorded musical signal without altering it and convert it to sound.

Challenging an audio system's ability to faithfully reproduce the recorded musical signal—and hence re-create the original musical event—is the system's susceptibility to mechanical resonances and vibrations. If an audio system has its own resonant signature, as imparted by such vibrations, then the audio system itself functions as an instrument. Such an audio system will color every instrument that it tries to reproduce, taking the listener further from a faithful re-creation of the original musical event.

A typical “high-end” audio system will include one or more source components (e.g., cd-player, turntable, etc.), a preamplifier, an amplifier and speakers. The spectral signature of these components is affected both directly and indirectly by mechanical resonances and vibrations. As to direct effects, these components are subjected to vibrations and resonances due to:
Mechanical coupling. The most significant source of mechanically-coupled vibration is the music itself. High-amplitude, low-frequency sound from the speakers mechanically couples through the floor of the listening room, up through the equipment rack into the bottom of a component. Furthermore, very low-level, low-frequency vibrations from passing vehicles, machinery and other sources can couple through the floor into audio components.
Acoustic pressure. Air-borne energy generated by the loudspeaker/room interface can directly couple to equipment racks, equipment enclosures, and then to signal-generating components.
Internal vibrations. Vibrations arise from sub-systems within the audio components themselves, such as mechanical drive systems (e.g., in cd players and turntables, etc.), spinning cooling fans (e.g., in amplifiers), and humming transformers. Even electric current moving through wires or other components can be a source of vibration. Specifically, current-induced magnetic fields that form around transformers, wires, and other passive devices can cause these components to vibrate or move slightly within their own fields. This creates minute non-linear currents that can subtly alter the original musical signal.

As to indirect effects, vibrations, varying in magnitude from very large (e.g., cabinet resonances that can be felt) to miniscule, can negatively affect playback through time- and frequency-domain disturbances.

To ameliorate the problems wrought by vibrations and resonances, various resonance- and vibration-control products have been developed. The products can be grouped generally into two classes: (1) footers and (2) platforms. Reducing vibrations and resonances through the use of these products has, in some cases, resulted in improvements in imaging, tonal balance, timing, treble focus, bass extension and detail.

Footers, as the name implies, are devices that are placed underneath an audio component and that replace the manufacturer-supplied “feet” that are supplied with the component (and which typically function simply as a standoff to prevent contact and damage to an underlying support shelf). A variety of footer designs have been developed, two of which are mentioned below.

In some cases, the footers are formed of a resilient material (e.g., Navcom™ Sorbothane™, etc.) that is intended to damp vibrations before they reach the supported component. In some other cases, the footers are rigid (e.g., cones, spikes, etc.). Although some rigid footers are alleged by their manufacturers to “drain” energy from the supported component, most function by merely shifting the frequency and level of the resonances.

Although effective to varying degrees, footers have their drawbacks. In particular, they can be difficult to place under audio components, especially if the components are enclosed in a cabinet. Furthermore, footer-supported components can be somewhat unstable. Resonance/vibration-control platforms address both of these problems.

Resonance/vibration-control platforms include (1) a base or platform on which the isolated component rests and (2) some type of mechanism for providing resonance/vibration-control for the platform. Several resonance/vibration-control platforms in the prior art are surveyed below.

One type of system includes one or more air-filled bladders that are located beneath a plinth (typically formed from medium density fiberboard). As the bladders are inflated, the plinth—and hence the component—“float,” thereby isolating the component from mechanically-coupled vibrations. In a second type of system, a plinth is placed on a substantial volume of sand. The sand conforms to the entire surface of the plinth and efficiently constrains and partially damps the platform's vibrational modes.

In a third type of system, several thermally-reactive copolymers are used as the primary damping material. The copolymers are contained in several modules underneath a plinth. Each different copolymer is intended to control resonances within a certain frequency range. The copolymers possess an ability to rapidly change durometer (i.e., relative hardness or softness). Movement or vibration creates friction in the module, which produces heat. The heat changes the durometer of compound in a pre-calculated manner based on the weight of the component it supports. As vibrations pass through the various modules, their amplitude decreases until they are substantially dissipated.

In a fourth type of system, magnetic levitation is used to isolate a supported component. In this system, coupled magnets that are oriented for repulsion are disposed underneath a plinth.

These various systems have drawbacks. For example, the technology and materials used in some of these systems are expensive, pushing the retail cost of some of these systems upwards of $1000. In some air-based systems, the air leaks out over time, requiring a user to occasionally re-balance the system by adding more air. For some systems, the customer provides information about the weight, weight distribution, and size of a component of interest and then the resonance/vibration-control system is designed based on these parameters. This limits the suitability of the platform for other equipment should the purchaser decide to replace the component for which the platform was designed. Some systems, such as magnetic levitation platforms, are particularly sensitive to uneven loads. In this regard, footers have an advantage since they can be appropriately positioned under a component to address an uneven weight distribution.

Many of the current resonance/vibration-platforms offer little flexibility to adapt to changes in the playback system. And no one resonance/vibration-control system is best for all components (e.g., one manufacturer's turntable vs. another's, etc.) in all situations (e.g., room construction, etc.). This is problematic because many audiophiles change their playback systems on a regular basis (at least compared to the music-listening public at large). Consequently, an “upgrade” in a source component might actually downgrade a playback system's ability to reproduce a recorded musical signal because a previous choice in a vibration-control platform is not suited to the new source component. This “upgrade” then occasions another purchase—a new vibration/resonance-control platform that is hopefully better suited to the new source component.

Consequently, there is a need for an improved resonance/vibration-control system.

### SUMMARY OF THE INVENTION

The illustrative embodiment of the present invention is a resonance/vibration-control platform (hereinafter referred to as a “vibration-control platform”) that avoids at least some of drawbacks of the prior art. The vibration-control platform reduces the magnitude of vibrations and resonances in objects that are placed on it.

Although the platform is useful for a variety of vibration-control applications, it is primarily intended to control vibrations and resonances in audio or video components. Vibrations and resonances will affect the ability of these components to faithfully reproduce a recorded music or video signal. Typical audio and video components that will be used with the platform include digital and analog source components (e.g., cd-players, dvd-audio players, sacd players, turntables, dvd-video players, etc.), amplifiers, preamplifiers, and any other components in the audio or video reproduction chain.

In the illustrative embodiment, the vibration-control platform includes a bottom plate having ten wells, a top plate, and a plurality of spherical vibration-control elements. The vibration-control elements are situated in some of the wells and sandwiched between the bottom and top plates. In use, an object is placed on the top plate of the vibration-control platform. In some alternative embodiments in which the optional top plate is not used, the object can be placed directly on top of the vibration-control elements.

Even though each of the ten wells in the bottom plate is physically adapted to receive one of the spherical vibration-control elements, for most applications, only three, four or five vibration-control elements are used and, as such, some wells in the bottom plate remain empty. The number and location of the wells that receive a vibration-control element is predominantly a function of the weight and weight distribution of the supported object. In the illustrative embodiment, the spherical vibration-control element is a resilient, hollow ball and the top plate and the bottom plate are formed of acrylic.

The vibration-control elements are readily removable from the wells in the bottom plate. This feature—the ability to rapidly and easily re-configure the spherical vibration-control elements on the vibration-control platform—provides several benefits to a user. One benefit is that it enables a user to “tune” a music system. More specifically, the amount and location of vibration-control elements on the bottom plate affects the performance of the platform and, therefore, the sound of a music system that incorporates the platform. As a consequence, a user can change the performance of a music system by altering these parameters.

A second benefit is that, to the extent that a first component that is being supported by the platform is to be replaced by a second component that has a different weight and/or weight distribution than the first component, it might be beneficial to change the number and/or position of the vibration-control elements for best performance.

The wells are structured so that:
1. the vibration-control elements have some freedom to move within the wells;
2. the vibration-control elements cannot be readily displaced from the wells during positioning of the platform; and
3. a centering or zeroing function is provided for the spherical vibration-control elements.

As to point 1, it is important that when situated within a well, the spherical vibration-control element retains an ability to move. If the ball is overly constrained, the performance of the platform will be degraded.

As to point 2, there would be a tendency for the spherical vibration-control elements to move out of the wells unless the wells are structured to prevent it. This undesirable movement might occur, for example, when attempting to place a heavy component on a vibration-control platform that is situated in a cramped location (e.g., audio rack, cabinet, etc.) such that it is difficult to place the component directly down on the top plate.

To provide the functionality described under points 1 and 2 above, and in accordance with the illustrative embodiment, each well comprises an outer rim or lip that surrounds a centrally-located dimple or trench. When a vibration-control element is in a well, it is seated in the dimple.

The rim of the well is recessed below the upper surface of the bottom plate. As such, a wall is defined at the outer periphery of the rim. This wall defines the perimeter of the well. The wall serves to retain a spherical vibration-control element should it be displaced from the dimple during placement of an object on the vibration-control platform. With regard to point 3 above, the dimensions of the rim (i.e., depth and width) and the size of the spherical vibration-control element are selected so that when a spherical vibration-control element is positioned within a well, it is “automatically” urged toward the dimple. That is, the well is structured to provide a zeroing function.

The present invention includes other features and provides other benefits, many of which are described in the Detailed Description and illustrated in the appended Drawings.

### BRIEF DESCRIPTION OF THE DRAWINGS

FIG. 1 depicts a perspective view of a vibration-control platform in accordance with the illustrative embodiment of the present invention. In the illustrative embodiment, spherical vibration-control elements are used. In FIG. 1, the vibration-control platform is shown with an optional top plate and shows an audio component disposed on the top plate.

FIG. 2 depicts a cut-away view of the vibration-control platform of FIG. 1, sans audio component.

FIG. 3 depicts the bottom plate of the vibration-control platform of FIG. 1.

FIG. 4 depicts a cross-sectional view of a well in the bottom plate of the vibration-control platform of FIG. 1.

FIG. 5 depicts a top view of the well of FIG. 4.

FIG. 6A depicts a cross-sectional view of a spherical vibration-control element properly seated in the dimple of the well of FIG. 4.

FIG. 6B depicts the cross-sectional view of FIG. 7A wherein the vibration-control element is not properly seated in the dimple.

FIG. 7A depicts a cross-sectional view of an alternative embodiment of the vibration-control platform, wherein the dimple has a hemispherical shape.

FIG. 7B depicts a cross-sectional view of an alternative embodiment of the vibration-control platform, wherein the dimple has a cylindrical shape.

FIG. 8A depicts a top view of an alternative embodiment of the vibration-control platform, wherein the perimeter of the well is polygonal.

FIG. 8B depicts a top view of an alternative embodiment of the vibration-control platform, wherein the perimeter of the dimple is polygonal.

FIG. 9A depicts a first arrangement of vibration-control elements on the lower plate of a vibration-control platform in accordance with the illustrative embodiment of the present invention.

FIG. 9B depicts a second arrangement of vibration-control elements on the lower plate of a vibration-control platform in accordance with the illustrative embodiment of the present invention.

FIG. 9C depicts a third arrangement of vibration-control elements on the lower plate of a vibration-control platform in accordance with the illustrative embodiment of the present invention.

FIG. 10 depicts a variation of the illustrative embodiment wherein the vibration-control platform includes a single well and several of these vibration-control platforms are used to support an object.

### DETAILED DESCRIPTION

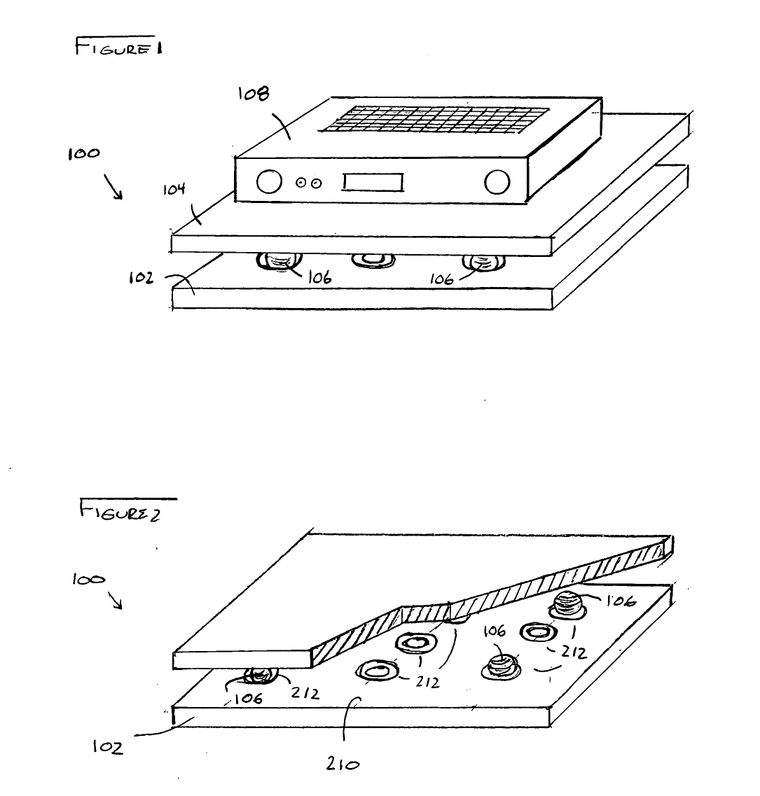

FIG. 1 depicts a perspective view of vibration-control platform 100 in accordance with an illustrative embodiment of the present invention. In the embodiment depicted in FIG. 1, vibration-control platform 100 includes bottom plate 102, optional top plate 104, and spherical vibration-control elements 106. Audio component 108 is disposed on top plate 104.

FIG. 2 depicts a cutaway view of vibration-control platform 100. As depicted in FIG. 2, bottom plate 102 has a plurality of wells 212. The wells are disposed on upper major surface 210 of bottom plate 102. Wells 212 receive spherical vibration-control elements 106. As depicted in FIG. 2 and described in more detail later in this specification, in most embodiments, only some of wells 212 receive spherical vibration-control elements 106; the other wells remain empty.

In some embodiments, bottom plate 102 and optional top plate 104 comprise acrylic, such as Acrylite™, commercially available from Cyro Industries of Rockaway, N.J. or others. Acrylic is advantageous for vibration control because its complex, dense, and irregular molecular structure is believed to hinder propagation of vibrations. Wells 106 are formed in acrylic using a boring blade or lathe. In some embodiments, bottom plate 102 or top plate 104 or both comprise multiple layers of the same or different material. For example, in some embodiments, bottom plate 102 comprises multiple layers of acrylic. In some other embodiments, other materials can suitably be used (e.g., any of a variety of woods, glass, other plastics, etc.).

In the illustrative embodiment, spherical vibration-control elements 106 are hollow, resilient balls, such as paddle balls, racquet balls, squash balls, etc. Such balls are commercially available from a variety of sources (e.g., sporting goods stores, department stores, toy stores, etc.), they are inexpensive compared with most vibration-control products, and they are available with a variety of resiliency characteristics (i.e., from relatively softer, spongier balls to relatively harder, less-yielding balls). The amount of resilience exhibited by a ball (e.g., due to its material of construction, internal pressure, etc.) will dictate the effect that the ball has on a given vibrational frequency and which specific frequencies it will affect.

One ball that has been found to be suitable for use as vibration-control element 106 is commercially available as the “NXT” paddle ball from Marox International, Inc. of Edison, N.J. These balls are made from neoprene rubber, have a diameter of 1.78 inches and a wall thickness of 0.3125 inches.

Although not resilient, solid balls of varying composition (e.g., carbide, stainless steel, silicon nitride, etc.) can be used in conjunction with the illustrative embodiment of the present invention. Further, other types of balls, such as golf balls and plastic balls can suitably be used.

It will be recognized that the effect that a particular “ball” has on the performance of vibration-control platform 100, and, hence, the way in which an audio/video system that incorporates the platform reproduces an audio signal or a video signal, will be the net result of a variety of factors. Such factors include, without limitation, the characteristics of the ball, the structure of bottom plate 102 and top plate 104, structural aspects of the component being supported, structural details of the listening room (e.g., concrete flooring, joist-supported flooring, etc.), the design of the equipment stands, etc. It is, therefore, very difficult to predict, a priori, the effect that a particular type of ball will have on the performance of an audio or video system. Consequently, the effect, and the choice of balls, is best determined empirically. And since the balls are typically widely available and inexpensive, such experimentation is easy.

FIG. 3 depicts a perspective view of bottom plate 102. In the illustrative embodiment, bottom plate 102 includes ten wells 212, which are organized into three columns. There are two “outer” columns 314 of wells, each of which include three wells 212. Outer columns 314 flank inner column 316, which has four wells 212. In some alternative embodiments, wells 212 are arranged differently (e.g., two outer columns of four wells flanking an inner column of two wells, two outer rows of three wells flanking an inner row of four wells, etc.). And in yet some additional embodiments, bottom plate 102 includes a different number of wells (e.g., typically six to thirteen wells).

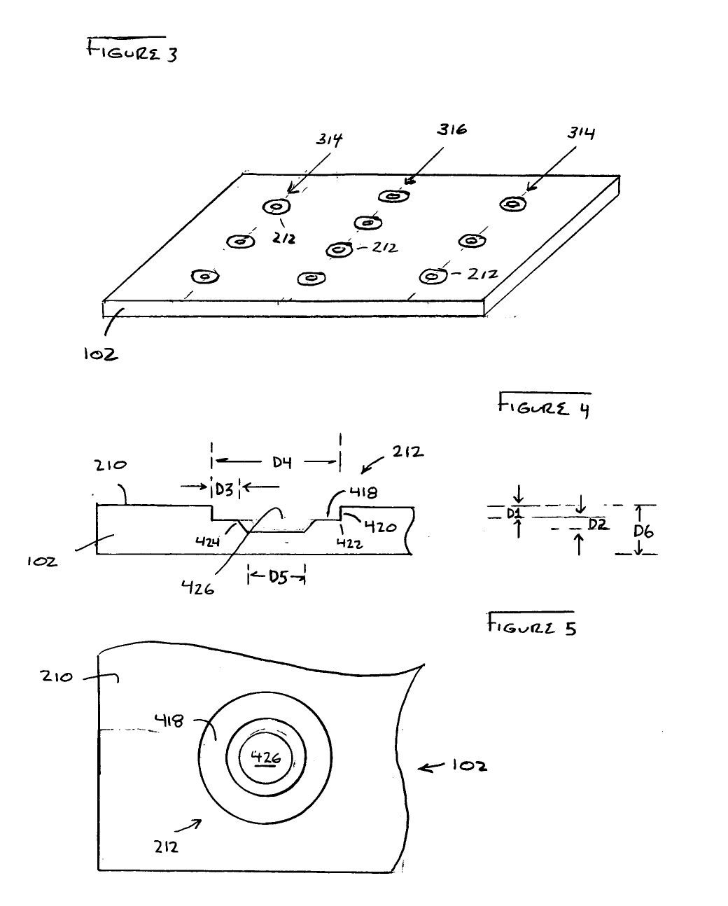

FIG. 4 depicts a cross sectional view and FIG. 5 depicts a top view of one of wells 212. Referring now to both of these Figures, well 212 includes an outer region, configured as a rim or lip 418 and an inner region, configured as dimple or trench 426. In the illustrative embodiment, dimple 426 and rim 418 are concentric.

Rim 418 is situated distance D1 below surface 210 of bottom plate 102. Wall 420 is defined in bottom plate 102 at outer periphery 422 of rim 418 as the interface between the recessed rim and the un-machined portion of bottom plate 102. Wall 420 defines the perimeter of well 212. Dimple or trench 426 is defined within inner periphery 424 of rim 418. Dimple 426 extends a distance D2 below rim 418. In the illustrative embodiment, wall 420 is substantially perpendicular to rim 418 and dimple 426 has a frusto-conical shape.

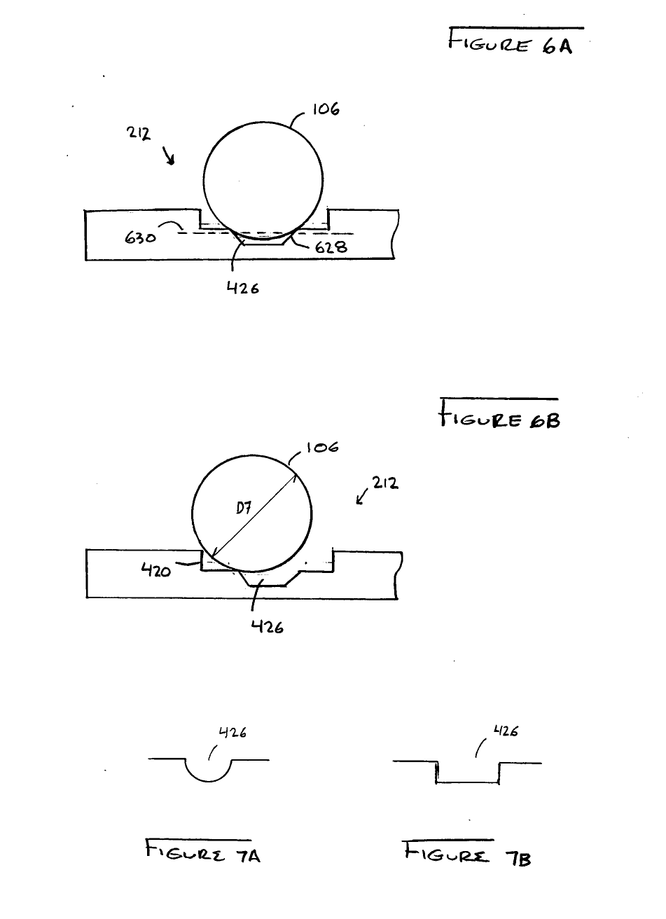

FIGS. 6A and 6B depict a cross section of well 212 and show spherical vibration-control element 106 within the well. In FIG. 6A, the vibration-control element is properly seated in dimple 426. As depicted in FIG. 6A, spherical vibration-control element 106 contacts wall 628 of dimple 426 at contact plane 630. In the illustrative embodiment that is depicted in FIG. 6A, the interface of spherical vibration-control element 106 with wall 628 of the conically-shaped dimple at contact plane 630 defines a contact perimeter having a circular shape. In most embodiments, contact plane 630 (and the contact perimeter) is located near the mouth of dimple 426 (i.e., near to the surface of rim 418).

Only a small portion of the surface of vibration-control element 106 that extends into dimple 426 actually contacts wall 628. This permits the vibration-control element to move more freely (in response to vibrations, etc.) than if there were a larger area of contact between the surface of the vibration-control element 106 and wall 628 of dimple 426. It is believed that this enhanced mobility improves the performance of vibration-control platform 100.

In FIG. 6B, spherical vibration-control element 106 is depicted as being not properly seated within dimple 426. Whether improperly placed within well 212 or dislodged from dimple 426 during movement of the vibration control platform, etc., wall 420 keeps the vibration-control element contained within well 212. In the absence of wall 420, the spherical vibration-control element would be free to roll far out of position.

Furthermore, the relative dimensions of the height D1 of wall 420, the width D3 of rim 418, and the diameter D7 of spherical vibration-control element 106 tend to force the vibration-control element into dimple 426. More particularly, these elements are dimensioned so that even when the vibration-control element abuts wall 420 (i.e., the vibration-control element is as far out of position as permitted by well 212), less than 50 percent of the weight of vibration-control element 106 is located over rim 418. In other words, the tendency is for spherical vibration-control element 106 to seat (or reseat) itself within dimple 426.

In the illustrative embodiment depicted in FIGS. 4 and 5, dimple 426 has a frusto-conical shape or cross-section. In some alternative embodiments, the dimple has a different shape. For example, in some embodiments, dimple 426 has a hemispherical shape, as depicted in FIG. 7A. And in some other embodiments, dimple 426 has a cylindrical shape, as depicted via a cross-sectional view in FIG. 7B. The shape of the cross-section of dimple 426 is somewhat arbitrary as long as the contact perimeter falls substantially in a plane. That is, there is advantageously a single point of contact between the surface of vibration-control element 106 and wall 628 of the dimple along any meridian (i.e., line of longitude) of the vibration-control element. Subject to this constraint, the shape of the cross section of the dimple will be typically be determined by manufacturing convenience.

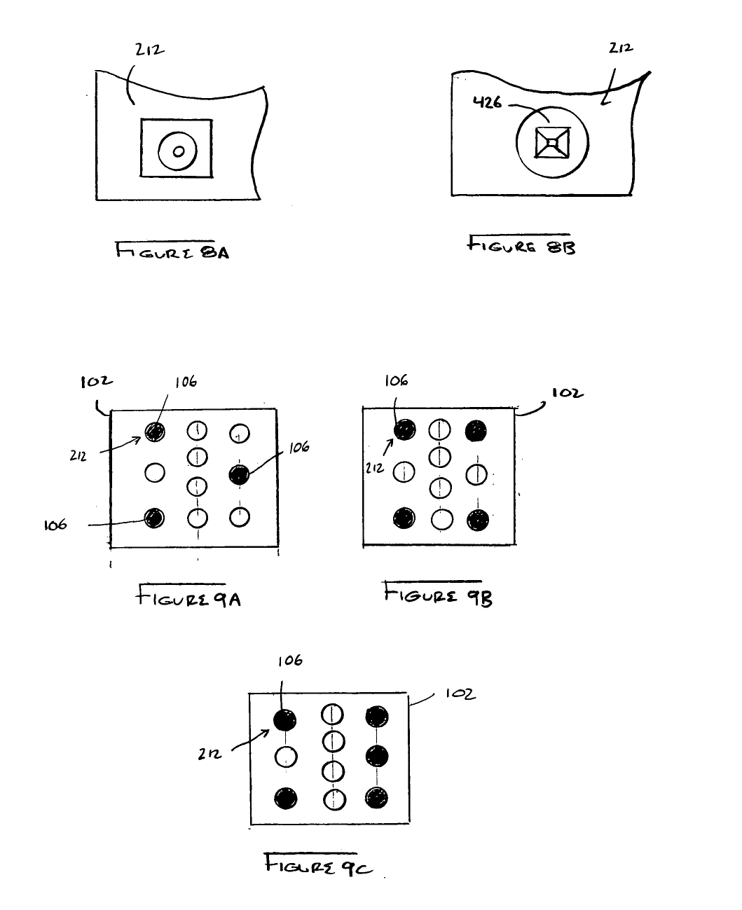

In the illustrative embodiment depicted in FIGS. 4 and 5, well 212 and dimple 426 have a circular perimeter. In some alternative embodiments, the perimeter of well 212 is not circular, but, rather, some other shape. For example, in some embodiments, the perimeter of well 212 is polygonal, as depicted in FIG. 8A. In yet some additional embodiments, the perimeter of dimple 426 is not circular, but, rather, some other shape. For example, in some embodiments, the perimeter of dimple 426 is polygonal, as depicted in FIG. 8B. In some other embodiments (not depicted), neither well 212 nor dimple 426 has a circular perimeter. The shape of the perimeter is predominantly a matter of manufacturing convenience.

It will be understood that in embodiments in which the perimeter of dimple 426 is polygonal, the shape of the dimple will not be conical or hemispherical. For example, in the dimple depicted in FIG. 8B, which has a square perimeter, the dimple has a four-sided pyrimidal shape. This pyrimidal shape provides the dimple with a “tapered” cross section. It will be recognized, however, that the dimple need not be tapered; that is, it can have a vertical cross section, as in the embodiment depicted in FIG. 7B. It is to be understood that the term “dimple,” as used herein, is intended to be generic and includes trenches, channels, etc., that have a shape that might not, according to a dictionary definition, be correctly described as a dimple.

Vibration-control platforms 100 having wells 212 that are dimensioned as indicated below have been built and found to provide the stated functionality. The range provided for each dimension is approximate and intended to be a guideline rather than a limitation.

| | | |
|---|---|---|
| Depth D1 of rim 418: | 0.375 inches | (range: 0.25-0.41 inches) |
| Depth D2 of dimple 426: | 0.25 inches | (range: 0.225-0.25 inches) |
| Width D3 of rim 418: | 0.5 inches | (range: 0.25-0.5 inches)* |
| Diameter D4 of well 212: | 2 inches | (range: 1.75-2.5 inches) |
| Diameter D5 of dimple 426: | 1 inch | (range: 0.25-1.5 inches) |
| Thickness D6 of bottom plate | 0.75 inches | (range: 0.75-1.25 inches) |
| 102: | | |
| Diameter D7 of spherical vib- | 1.78 inches | (range: 1.5 to 1.9 inches) |
| ration-control element 106: | | |

The maximum width D3 of rim 418 should be such that less than 50 percent of the spherical vibration-control element 106 is positioned over rim 418.

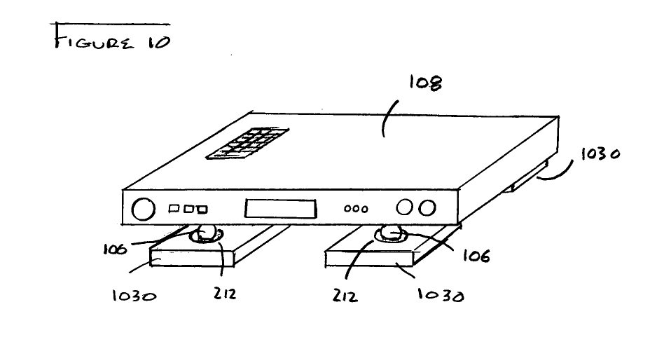

As previously described, in the illustrative embodiment, bottom plate 102 includes ten wells 212. Typically, only some of the wells will receive vibration-control element 106. FIGS. 9A, 9B, and 9C depict several different arrangements of vibration-control elements 106 within wells 212. In the arrangement depicted in FIG. 9A, three vibration-control elements 106 are positioned in a triangular arrangement within three of wells 212 in bottom plate 102. In FIG. 9B, four vibration-control elements 106 are disposed in a rectangular arrangement within four of wells 212 of bottom plate 102. And in FIG. 9C, five vibration-control elements 106 are disposed in five of wells 212 of bottom plate 102.

The number of vibration-control elements 106 that are used, and the specific wells 212 in which they are placed, is primarily a function of the weight of the object that is to be supported and the weight distribution of the object. More particularly, in the illustrative embodiment wherein resilient, spherical vibration-control elements 106 are used, there is typically an acceptable and optimal weight loading per vibration-control element. For example, for some hollow, resilient paddle balls, acceptable loading is in the range of about 5 to 20 pounds per ball, with an optimum weight loading of about 10 pounds per ball. As used herein, the phrase “optimal weight loading” means the load that substantially maximizes the vibration-reducing quality of the platform over a tested frequency range.

To determine the number of vibration-control elements 106 to be used, the weight of the supported object is simply divided by the optimal weight loading per element 106. To the extent that the weight of the supported object is not uniformly distributed, it might be desirable, as a function of the extent to which the weight distribution is skewed, to position more of the vibration-control elements beneath the more heavily-weighted portion of the object.

Bottom plate 102 and top plate 104 are typically sized as a function of the objects that they will be supporting. Illustrative vibration-control platform 100 is typically used with audio and video components, which are typically 12 to 19 inches across and about 10 to 16 inches deep. In some embodiments, top plate 104 is 19 inches across and 16 inches deep and bottom plate 102 is 16 inches across and 13 inches deep.

FIG. 10 depicts an alternative embodiment of a vibration-control platform in accordance with the present invention wherein bottom plate 102 is replaced by a plurality of smaller plates 1030, each of which has a single well 212. In this embodiment, a top plate is not used; component 108 rests directly on vibration-control elements 106. Although each plate 1030 includes only a single well, they provide similar placement flexibility to plate 102, which has a plurality of wells 212. In particular, a plate 1030 can be placed anywhere underneath an object as appropriate for stable support and for balancing the weight distribution of the object.

It is to be understood that the above-described embodiments are merely illustrative of the present invention and that many variations of the above-described embodiments can be devised by those skilled in the art without departing from the scope of the invention. It is therefore intended that such variations, and others that will occur to those skilled in the art in view of the present disclosure, be included within the scope of the following claims and their equivalents.

1. An article comprising a bottom plate, wherein said bottom plate has a first major surface, and further wherein said first major surface comprises at least one well for receiving a spherical vibration-control element, wherein said well comprises:
an outer region and an inner region, wherein:
said outer region is disposed a first distance below said first major surface;
an outer periphery of said outer region defines a perimeter of said well;
an inner periphery of said outer region defines a perimeter of said inner region;
said inner region extends to a second distance below said outer region defining a dimple; and wherein:
the relative sizes of said perimeter of said well, said perimeter of said dimple, said first distance, and a diameter of said spherical vibration-control element are such that when said vibration-control element is received by said dimple, it does not contact said perimeter of said well.

2. The article of claim 1 wherein said well has a circular perimeter and said outer region has an annular shape.

3. The article of claim 1 wherein said inner region and said outer region are co-axial.

4. The article of claim 1 wherein said dimple has a frusto-conical cross section.

5. The article of claim 4 wherein only a minor portion of said vibration-control element extends into said dimple.

6. The article of claim 5 wherein, of said portion of said vibration-control element that extends into said dimple, only a minor portion thereof contacts a surface of said dimple.

7. The article of claim 1 wherein said outer region is dimensioned and arranged so that a spherical vibration control element that is disposed in said well is urged toward said inner region.

8. The article of claim 2 wherein said well has a diameter of about 2 inches and a diameter of said spherical vibration control element is smaller than said diameter of said well.

9. The article of claim 1 wherein a wall is defined at said outer periphery of said outer region.

10. The article of claim 1 further comprising said vibration-control element.

11. The article of claim 10 wherein said vibration-control element comprises a hollow, resilient ball.

12. The article of 1 wherein said bottom plate comprises a plurality of wells.

13. The article of claim 1 wherein said bottom plate comprises acrylic.

14. An article comprising a plate, wherein said plate has at least one well for receiving a vibration control element, and wherein said well comprises a rim and a dimple, and further wherein:
said rim surrounds said dimple;
said rim is disposed a first distance below a surface of said plate; and
said rim is dimensioned and arranged so that so that when said vibration-control element is positioned in said well, said vibration-control element is urged toward said dimple.

15. The article of claim 14 wherein when said vibration-control element is disposed in said dimple, said vibration-control element does not abut a perimeter of said well.

16. The article of claim 14 wherein said lip is planar.

17. The article of claim 14 wherein a diameter of said well is in a range of about 1.75 inches to about 2.5 inches, a diameter of said vibration control element is in a range of about 1.5 inches to about 1.9 inches, and a diameter of said dimple is about 0.25 inches to about 1.5 inches.

18. An article comprising a plate, wherein said plate has at least one well for receiving a spherical vibration-control element, and wherein said well comprises:
a dimple; and
a rim, wherein said rim surrounds said dimple, and wherein rim is disposed a first distance below a surface of said plate.

19. The article of claim 18 further comprising said spherical vibration-control element.

20. The article of claim 19 wherein said plate comprises acrylic.
